(19) United States
(12) Patent Application Publication
(10) Pub. No.: US 2017/0356601 A1
(43) Pub. Date: Dec. 14, 2017

(54) High-Output LED AC Bulb Replacement Assembly

(71) Applicants: Benny Ray Smith, Santa Rosa, CA (US); Peter Andrew Smith, Hidden Valley Lake, CA (US)

(72) Inventors: Benny Ray Smith, Santa Rosa, CA (US); Peter Andrew Smith, Hidden Valley Lake, CA (US)

(21) Appl. No.: 15/181,895

(22) Filed: Jun. 14, 2016

(51) Int. Cl. F21K 9/232; F21K 9/60; F21V 29/56; F21V 23/06; F21V 29/70; F21V 5/04; F21V 29/60; H05B 33/08; F21Y 2115/10

(52) U.S. Cl. CPC F21K 9/232; F21V 5/045; F21K 9/60; F21V 29/56; F21V 29/60; F21V 23/06; F21V 29/70; F21Y 2115/10; H05B 33/0845

(57) ABSTRACT

A direct, plug-in replacement assembly for the halogen bulb used in existing lighting instruments that are employed in motion picture, video and stage productions. The assembly is self-contained and powered from the same socket as the original bulb. The assembly is designed to fit into the existing lighting instrument without any modification of that instrument. The assembly incorporates an LED array along with an electronic and mechanical system for thermal management. Standard phase-control AC dimmers are fully compatible with the assembly.

### CROSS-REFERENCES TO RELATED APPLICATIONS

None

### STATEMENT REGARDING FEDERALLY-SPONSORED RESEARCH OR DEVELOPMENT

Not Applicable

### MICROFICHE APPENDIX

Not Applicable

### BACKGROUND OF THE INVENTION

### 1. Field of the Invention

The invention comprises an optional replacement for the halogen bulb which is commonly used in lighting instruments that are designed to light motion picture, video, and stage productions.

### 2. Description of the Related Art

The lighting instruments that have been in use for decades employ halogen light bulbs as their light source. The power consumption of these instruments ranges from hundreds to thousands of watts. Typically, 93% or more of this power is converted to heat, leaving 7% to be converted to light. This is the impetus for many users of these instruments to desire conversion to LEDs, which can provide eight times as much light for the same power draw.

Fresnel lenses have been used for centuries to project light from a point source into a spot of variable size. The size of the projected light beam can be varied by moving the light source back and forth with respect to the lens. Since halogen bulbs emit significant infrared heat energy, the Fresnel lens that is incorporated into a typical halogen instrument must be capable of withstanding extreme heat. Such lenses are typically made from thick, stepped glass.

These halogen bulbs typically use dual-pin, bayonet or screw bases as their interface to a socket, the socket being connected to mains power via a power cord.

### BRIEF SUMMARY OF THE INVENTION

The invention comprises a direct, plug-in replacement for the halogen bulb used in existing lighting instruments. The invention consists of an LED array, a thermal-management system, a power supply and a power connector. The invention installs in the existing socket of the Fresnel instrument through a compatible power connector. Power is fed from the AC mains through this connector to the power supply, which provides power for the LED array and, in some cases, to the thermal management system. A distinguishing feature of this invention is that it allows the light intensity emitted by the LED array to be continuously varied by means of a standard, external, phase-control AC dimmer in the same manner as the halogen bulb's intensity may be varied by the same dimmer.

### SUMMARY OF THE VARIANTS OF THE INVENTION

Since there are many variations of lighting instruments which incorporate halogen or other incandescent bulbs, the present invention can take various forms in order to replace the bulb in each of these instruments. There are two primary differences that distinguish the different versions of the present invention:

a) the means by which the interface between the AC mains connector socket in the existing Fresnel lighting instrument and the present invention is achieved. This can be accomplished via cylindrical pins or various other mechanical/electrical interfaces;
b) the means by which the heat produced by the LED array is transferred to the environment. This may include natural convection only, forced air, liquid cooling, or some combination of those methods. The size, constituent parts, and configuration of the LED cooling apparatus are chosen to specifically accommodate the instrument into which the present invention is being placed.

### BRIEF DESCRIPTION OF THE DRAWINGS

Having thus described various embodiments of the invention in general terms, reference will now be made to the accompanying drawings, which are not necessarily drawn to scale, and wherein:

FIG. 1 is a perspective view of the present invention.

FIG. 2 is a perspective view of a convection-cooled embodiment of the present invention.

FIG. 3 is a perspective view of a forced-air-cooled embodiment of the present invention.

FIG. 4 is a perspective view of a liquid-cooled embodiment of the present invention

FIG. 5 is a functional block diagram of the power-supply/thermal-management module.

REFERENCE NUMERALS IN THE DRAWINGS

| | | | |
|---|---|---|---|
| 10 | Cooling module | 12 | LED array |
| 14 | Power supply | 16 | Power connector |
| 18 | Finned-aluminum heat sink | 20 | Pin-fin aluminum heat sink |
| 22 | DC cooling fan | 24 | Liquid cooling heat sink |
| 26 | Coolant hoses | 28 | Radiator |
| 30 | DC cooling fan | 32 | AC Line filter |
| 34 | Full-wave rectifier | 36 | Voltage buffer |
| 38 | Constant-current regulator | 40 | AC to DC supply |
| 42 | Micro-controller | 44 | +12 V DC fan |
| 46 | Over-temperature shut-off | 48 | Dimmable controller |

### DETAILED DESCRIPTION OF THE INVENTION

The invention consists of four main sub-systems: a cooling module (10); an LED array (12); a power-supply module (14); and, a power connector (16). FIG. 1 shows a three-dimensional, perspective view of these four subsystems connected together.

The LED array (12) provides all of the light that is produced by the present invention. In normal operation, the LED array (12) produces a significant amount of heat, which must be adequately removed in order to maintain a stable operating condition for the LED array. The LED array is mounted in intimate thermal contact with the cooling module.

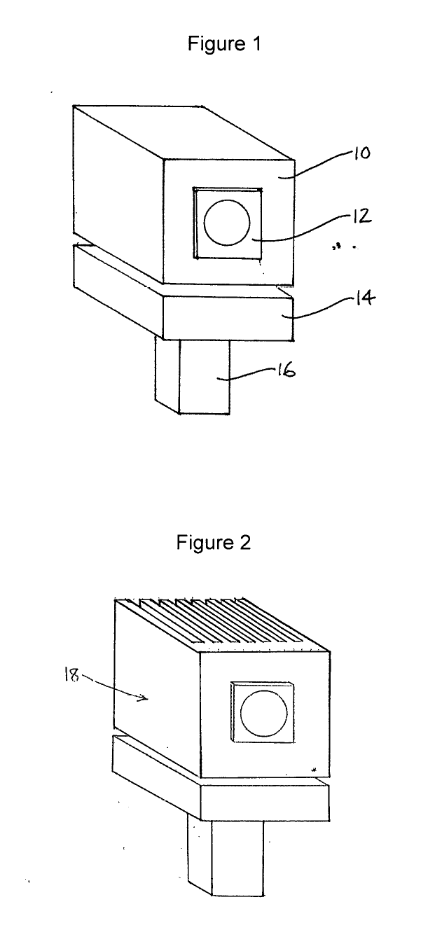

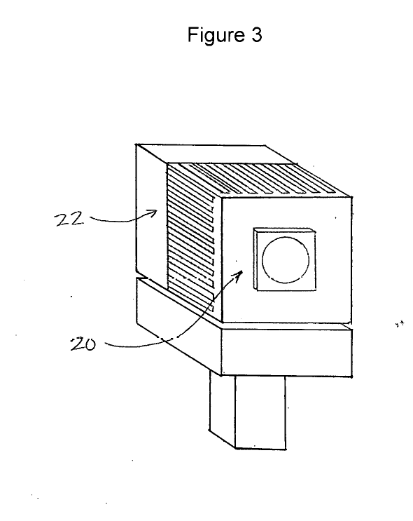

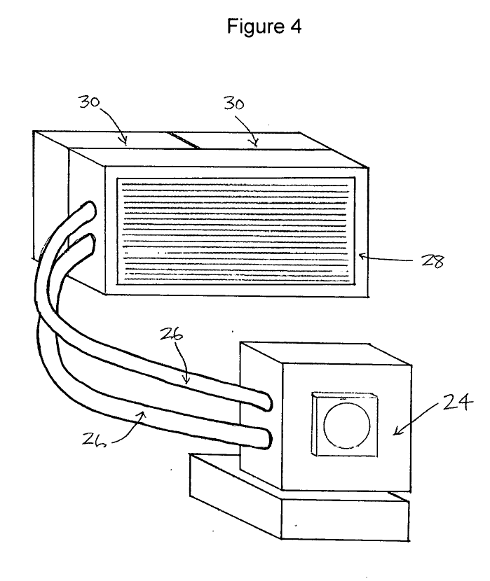

The cooling module (10) removes heat from the LED array (12) and maintains the LED array at a suitable operating temperature. The cooling module may have one of several alternate embodiments. FIG. 2 illustrates one possible embodiment of the cooling module which employs a finned, solid-aluminum heat sink (18) which is cooled by natural convection. FIG. 3 illustrates another possible embodiment which employs a finned, solid-aluminum heat sink (20) plus a cooling fan (22) to provide forced air. FIG. 4 illustrates another possible embodiment which employs a fluid-filled heat sink (24) connected by coolant hoses (26) to a remote radiator assembly (28) which is cooled by forced air from one or more fans (30).

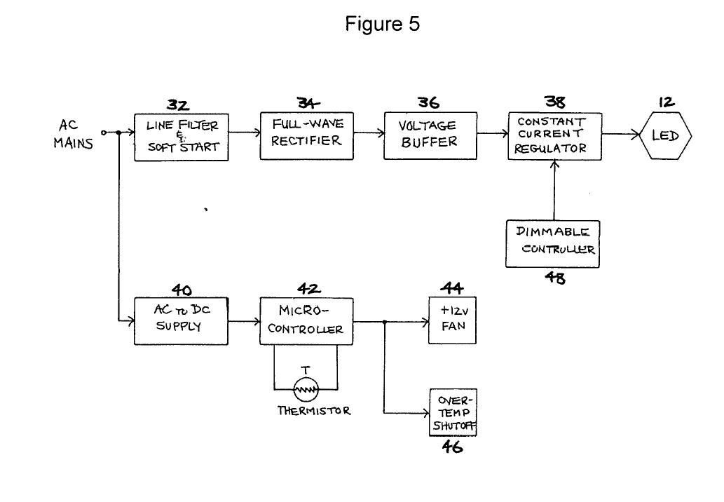

FIG. 5 shows a functional block diagram of the power supply module (14). The power supply module (14) consists of a printed-circuit assembly and a remote temperature sensor. The power supply module converts the AC mains voltage to a current of a suitable level for driving the LED array. The power supply module incorporates a line filter (32) to reduce the level of electromagnetic interference that is fed back into the mains circuit. The line filter also includes a soft-start mechanism to suppress destructive current surges into the remainder of the power supply and control circuit. A full-wave rectifier (34) and voltage buffer (36) combine to produce a pulsating DC voltage which is fed to the constant-current regulator (38). The constant-current regulator consists of a power inductor which is switched at approximately 400 kHz by a dimmable controller (48) to apply the correct voltage and current levels to the LED array for proper operation at the chosen brightness level. A power FET and a power rectifier handle the high-current required to drive the LED array. The power FET and power rectifier, along with the LED array, are mounted directly on the cooling module. The dimmable controller (48) consists of a special-purpose integrated circuit and associated components which serve to create a drive signal for the power FET. This drive signal responds to the envelope of the AC mains input voltage, which may be controlled by an AC in-line phase-control dimmer. The present invention will work equally well with or without a dimmer.

Within the power supply module, an AC-to-DC power supply (40) is used to generate an appropriate DC voltage level to power the micro-controller (42). The micro-controller requires one input signal and provides two output signals. The input signal is provided by an NTC thermistor, which senses the temperature of the cooling module in the vicinity of the LED array and provides a DC-voltage level to the micro-controller. This voltage is converted to a digital value by the micro-controller's on-board analog-to-digital converter. One output signal from the micro-controller is used to control a cooling fan, if such a fan is present in the specific embodiment of the present invention. The second output signal is used to modulate or interrupt the power to the LED array in the event of an over-temperature condition.

Where a cooling fan is employed in the embodiment of the present invention, said fan must be capable of pulse-width-modulation speed-control. A proportional-integral-derivative (PID) algorithm is used in the micro-controller's software to maintain the temperature of the cooling module at a particular value set in the software. The cooling fan is commanded by the software to speed up or slow down, as necessary, in order to maintain the LED array temperature at the set-point value.

The power connector module (16) is designed to connect the power supply module (14) and the AC mains receptacle in the particular Fresnel instrument into which the present invention is to be placed. In one particular embodiment of the power connector module, the AC mains connection takes the form of a pair of cylindrical posts which insert into cylindrical AC receptacles in the Fresnel instrument. Another embodiment utilizes a single, bipolar, cylindrical connector which provides the AC connection to the Fresnel instrument. Numerous other embodiments are possible and necessary to interface to other existing Fresnel instruments. Every embodiment of the power control module is directly connected to the power supply module.

1. An assembly to replace standard halogen bulb variants used primarily in video, motion picture, and stage lighting equipment, wherein said assembly consists of an LED array or an array of LED arrays, a cooling module, a power supply module and a power connector, wherein said power supply module accepts AC power, and wherein said power connector is configured with a compatible plug to fit into the socket within the specific lighting instrument into which it is placed.

2. The assembly of claim 1, wherein the light intensity of the LED array may be controlled by a conventional AC dimmer, which applies a variable AC voltage to the assembly via the power connector.
Cooling Claims:

3. The assembly of claim 1, wherein the cooling module consists of a heat-sink and fan combination designed to use forced air for heat removal.

4. The assembly of claim 1, wherein the cooling module consists of a passive heat sink designed to use only natural air convection for heat removal.

5. The assembly of claim 1, wherein the cooling module consists of a liquid-cooled heat-sink which passes the heat via liquid in hoses to a heat radiator assembly which is cooled by forced air.

6. The assembly of claim 1, wherein the cooling module consists of a liquid cooled heat-sink which passes the heat via liquid in hoses to a heat radiator assembly which is cooled by natural air convection.

7. The assembly of claim 1, wherein the cooling module consists of a liquid cooled heat-sink which passes the heat via liquid in hoses to a heat sink mounted with a thermal interface connecting to the existing housing of the instrument, using natural air convection to cool the existing housing of the instrument.
Power Connector Claims:

8. The assembly of claim 1, wherein the power connector is compatible with a standard bi-post socket.

9. The assembly of claim 1, wherein the power connector is compatible with a standard twist-lock socket.

10. The assembly of claim 1, wherein the power connector is compatible with a standard double-ended receiver socket.
Optical Claims:

11. The assembly of claim 1, wherein the light from the LED is augmented by a reflector or series of reflective or prismatic surfaces to effect the desired projection of the light.

12. The assembly of claim 1, wherein the light is collimated through a Fresnel lens.

13. The assembly of claim 1, wherein the light is collimated through a Fresnel lens and wherein the assembly of claim 1 moves upon the instrument's existing carriage in order to focus the light through the lens.

14. The assembly of claim 1, wherein the light is reflected from a white surface to produce a soft-light.
